(19) United States
(12) Patent Application Publication
(10) Pub. No.: US 2004/0205463 A1
(43) Pub. Date: Oct. 14, 2004

(54) Apparatus, program, and method for summarizing textual data

(76) Inventor: William P. Darbie, Fort Collins, CO (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/054,155

(22) Filed: Jan. 22, 2002

(51) Int. Cl. G06F 17/24

(52) U.S. Cl. 715/500; 707/6

(57) ABSTRACT

Improved apparatuses, programs, and methods for navigating summarized data are disclosed. Textual data is received, converted into hypertext markup language, and the converted data searched for operator selectable strings indicative of data items having a relatively higher level of import. Information extracted from the converted data is summarized in a report that includes a link from the summary to the location of the string in the converted data.

### TECHNICAL FIELD

The present disclosure relates generally to apparatuses, computer programs, and methods for summarizing the content of textual data, and in particular, to apparatuses, computer programs, and methods for generating reports responsive to information contained within the textual data.

### BACKGROUND OF THE INVENTION

Recent advances in technology, such as increases in data processing rates and data storage technology, have made it possible to generate text data files that contain an overwhelming quantity of information. Manual observation and analysis of large text data files is an onerous task that is both time consuming and error prone. As may be expected, both the time it takes to observe and analyze a particular text data file increases as a function of the length (i.e., size) of the data file. It is also expected that the number of errors introduced in the analysis of large files that contain repetitive and/or highly detailed information will increase as a function of the size of the file, the level of detail in the information contained therein, and perhaps other factors, such as the font, font size, and line spacing selected for formatting the data.

The miniaturization of electronic circuit components has made it increasingly difficult to manually inspect and test various printed circuit card assemblies. As a result, a number of different systems have been employed to automatically inspect and test printed circuit card assemblies. These and other systems require human intervention, often in the form of programming, in order to ensure thoroughness in the inspection and functional testing of each particular assembly. While most information regarding the arrangement, type, solder joints, and other information associated with the components on a printed circuit card assembly may be conveyed to the inspection system via automated information transfers, such as a data file transfer, human intervention is required to correct incorrect information that may be transferred to the inspection system. Human intervention may also be required to communicate to the test machine specific information concerning how to test the printed circuit assembly. For example, tests, test types, and test parameters often need to be conveyed to the inspection system.

One exemplar inspection system is the 5DX, a solder-joint inspection system, commercially available from Agilent Technologies, Inc. of Palo Alto, Calif., USA. The 5DX is designed to provide an automated quality assurance inspection of the various structures of a printed circuit card assembly. Each particular printed circuit card may contain dozens or even hundreds of integrated circuit devices, surface mount devices, and/or other styles of discrete components that may be structurally and electrically integrated with the printed circuit card assembly through solder joints.

In order to automatically inspect each of the solder joints on a particular printed circuit card assembly, information regarding the type, location, and acceptable characteristics of each of the solder joints associated with the printed circuit card assembly must be communicated to the 5DX. An operator of the 5DX, after having communicated the necessary information regarding the printed circuit card assembly, is presented a test compiler tool that generates multiple pages of highly detailed text concerning the printed circuit card assembly of interest. The text in some cases may contain errors and warnings. For automated tests contemplated with the 5DX, each error must be corrected before the system will commence testing. As explained above, a particular error may be overlooked when manually observing the text data.

Commonly available word processors have the ability to search through a text file to locate matches for a particular text string such as “error.” However, available word processors do not have the capability to automatically generate a summary of information in the text and associate particular information items from a summary with the underlying text data.

In addition, some software development environments available today provide a tool that permits a programmer to select a particular anomaly identified by a compiler in order to locate the underlying source code that generated the problem. Borland's JBuilder™ 6.0 is an example of a product that provides this function. However, available software development environments do not provide the flexibility to work on text output generated outside of their own environment. Software development products only work with the text output that they generate. They do not have the flexibility to work with output from other sources. Therefore, a tool like JBuilder™ 6.0 cannot be used by someone tasked with reviewing and responding to reports and/or summaries generated from large text data files.

Despite the capabilities now available to locate instances of a particular text string and to associate a compiler identified anomaly with the portion of the underlying source code that initiated the problem, it can be appreciated that it would be desirable to have an improved apparatus, program, and method for improving the flexibility of analyzing a report and/or summary generated in response to the information contained within a text data file.

### SUMMARY OF THE INVENTION

In response to these and/or other perceived shortcomings of the prior art, apparatuses, computer programs, and methods for navigating summarized textual data are disclosed. The present invention provides a text enhancer and methods for navigating summarized textual data. An operator of the text enhancer may significantly reduce the number of times that an important portion of a text file is “overlooked.” A text enhancer configured to practice the methods for navigating summarized textual data permits an operator to enter one or more data strings of particular interest or importance. The text enhancer converts the text data into a hypertext markup language representation of the textual data and associates information in a summary of the underlying information with the text string that initiated the entry in the summary. The text enhancer may accomplish the association by providing a link between the entry in the summary and the underlying information in the representation of the textual data. In this way, the text enhancer provides a flexible solution to the problem of navigating through a text data file.

In one arrangement, the text enhancer includes: a conversion engine configured to transform text data into a hypertext markup language format; a query engine configured to locate a match between a text string and the text data; a content-reporting engine configured to generate an entry reflective of a number of located matches; a data-indexing engine configured to associate the text string and the transformed text data such that a user of the system can navigate between the entry reflective of the number of matches and the transformed text data.

Some embodiments can be viewed as providing methods for navigating summarized textual data. In this regard, an embodiment of one such method can be summarized by the following steps: a) transforming data from a text format to a hypertext markup language format; b) receiving indicia of a portion of text; c) comparing the contents of the transformed data with the indicia to identify a match; d) generating an entry responsive to the recorded match; e) inserting the entry in a data summary; and f) associating the entry with the contents of the transformed data responsible for the match.

Other embodiments can be viewed as providing an embodiment of one such computer program. In this regard, the program may include: logic configured to receive text data; logic configured to translate the text data to a hypertext markup language format; logic configured to locate a text string within the hypertext markup language format information; logic configured to account for located text strings; logic configured to sequence a respective label in a text data summary; and logic configured to associate a particular label with occurrences of the particular text string located within the underlying hypertext markup language format information.

Clearly some embodiments may exhibit advantages and features in addition to or in lieu of those summarized above and described in detail below.

Other systems, methods, and features associated with the text enhancer and the methods for navigating summarized data will become apparent to one with skill in the art upon examination of the following drawings and detailed description. It is intended that all such additional systems, methods, and features included within this description, are included within the scope of the text enhancer and the method for summarizing data as protected by the accompanying claims.

### BRIEF DESCRIPTION OF THE DRAWINGS

The text enhancer and method for summarizing textual data can be better understood with reference to the following drawings. The components in the drawings are not necessarily to scale emphasis instead is placed upon clearly illustrating the principles of the text enhancer and the method for summarizing textual data. Furthermore, in the drawings, like reference numerals designate corresponding parts throughout the several views.

FIG. 1 is a functional block diagram illustrating an embodiment of a text enhancer.

FIG. 2 is a diagram illustrating the various components of an exemplar computing device configured with the text enhancer of FIG. 1.

FIG. 3 is a diagram illustrating the various functional logic contained within the text enhancer of FIGS. 1 and 2.

FIG. 4 is a flow diagram that illustrates an embodiment of a method for summarizing textual data that may be practiced by the text enhancer of FIGS. 1 and 2.

FIGS. 5A-5E present an exemplar representation of each page of a multiple page text file that may be provided to the text enhancer of FIGS. 1 and 2.

FIGS. 6A-6E present an exemplar representation of each screen of a multiple screen display that may be generated by the text enhancer of FIGS. 1 and 2 when presented the multiple page text file of FIGS. 5A-5E.

FIG. 7 is a flow diagram that illustrates an alternative embodiment of a method for summarizing textual data that may be practiced by the text enhancer of FIGS. 1 and 2 to produce the multiple screen display of FIGS. 6A-6E.

### DETAILED DESCRIPTION

The present invention provides a text enhancer and a method for navigating summarized textual data. As summarized above, an operator of the text enhancer may significantly reduce the number of times that an important portion of a text file is “overlooked.” A text enhancer configured to practice the methods for navigating summarized textual data permits an operator to enter one or more data strings of particular interest or importance. The text enhancer converts the text data into a hypertext markup language representation of the textual data and associates information in a summary of the underlying information with the text string that initiated the entry in the summary. The text enhancer may accomplish the association by providing a link between the entry in the summary and the underlying information in the representation of the textual data. In this way, the text enhancer provides a flexible solution to the problem of navigating through a text data file.

A link may be indicated by any of a number visual indicators shared by the entry in the summary and the underlying information within the text. For example, when the summary and text are presented in a hard-copy format, the link may be indicated by color with both the summary information and the underlying text sharing the same color print. When presented in a hard-copy format with a single color font, the link may be indicated by a link identifier formed by any combination of desired alphanumeric characters (e.g., a number, a character, a label, etc.) In other embodiments, the link may be indicated by changing the font of both the entry in the summary and the associated data in the text. When presented by way of a display device having a graphical user interface (GUI), a link may also include a pointer or other mechanism that associates the entry in the summary and the underlying text in the body of the data, thereby allowing a user to quickly navigate through both the summary and the underlying data by jumping to the associated text in the body when the associated entry in the summary is selected and jumping back to the associated entry in the summary when the associated data in the body of the text is selected.

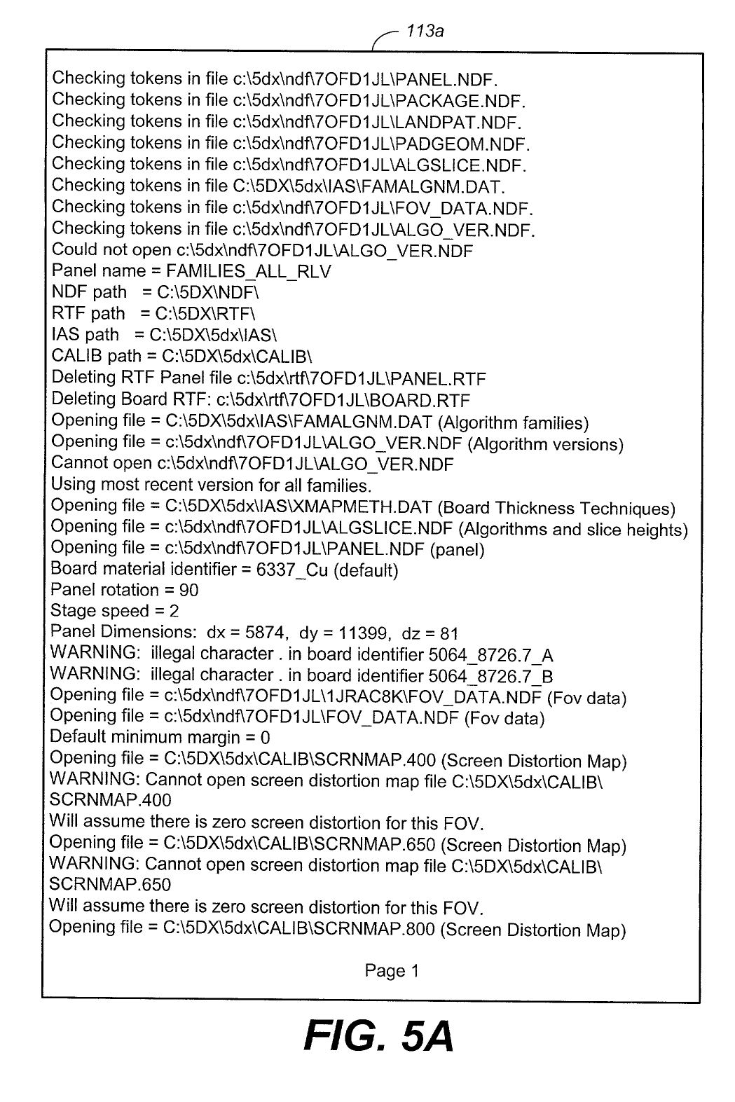

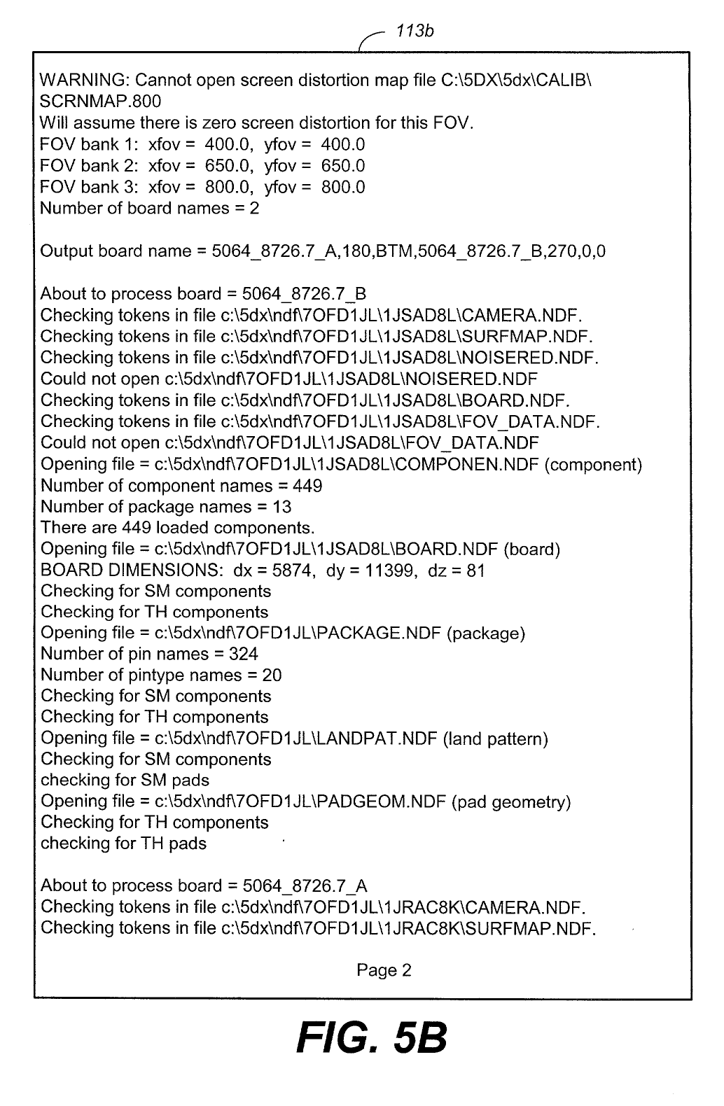

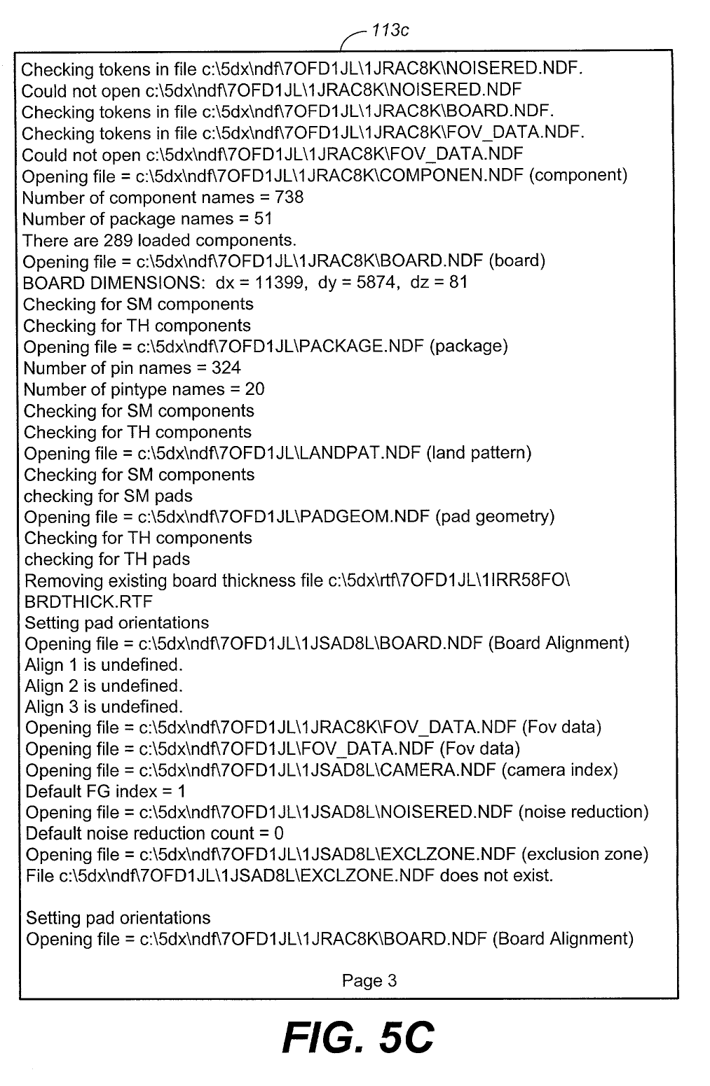

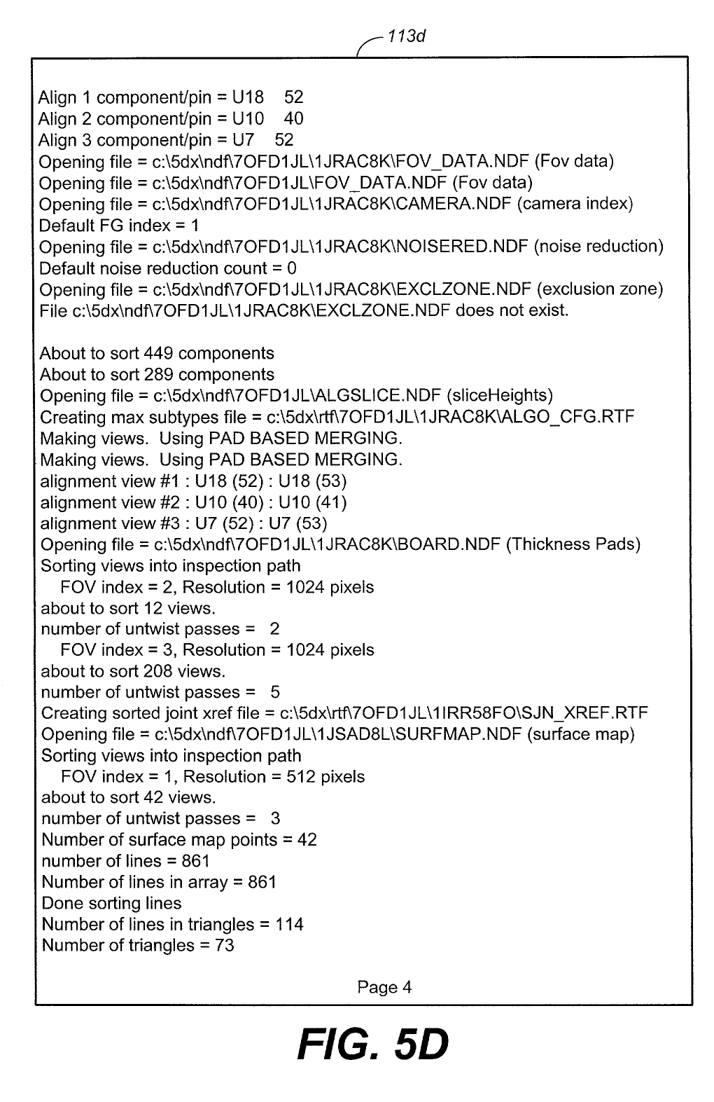

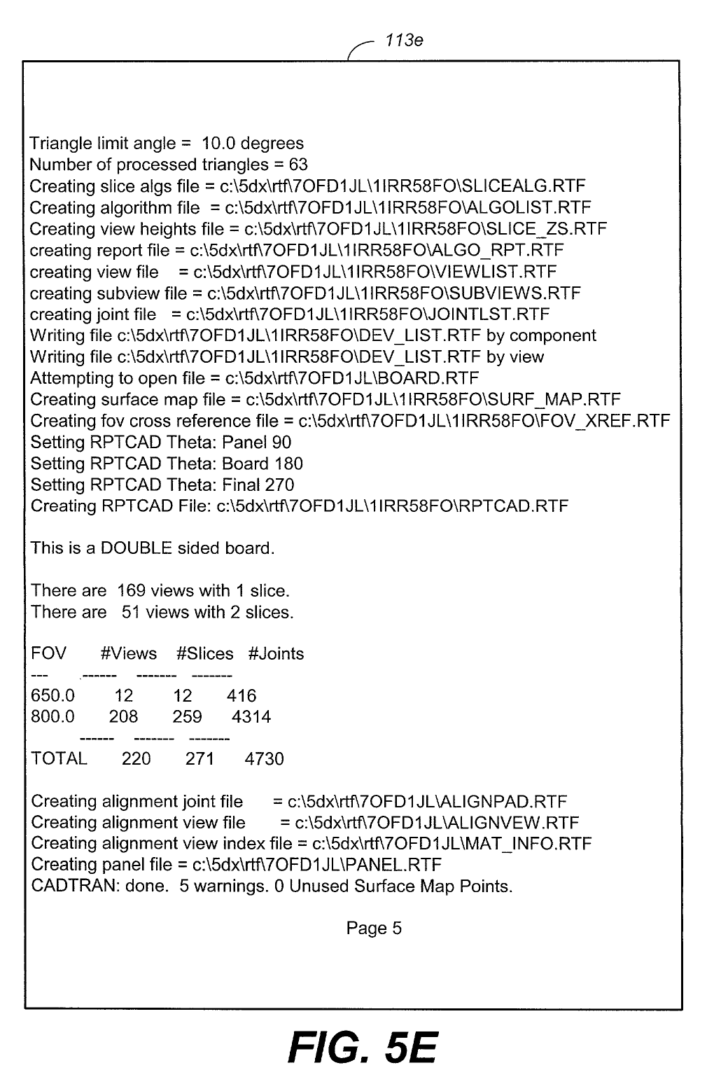

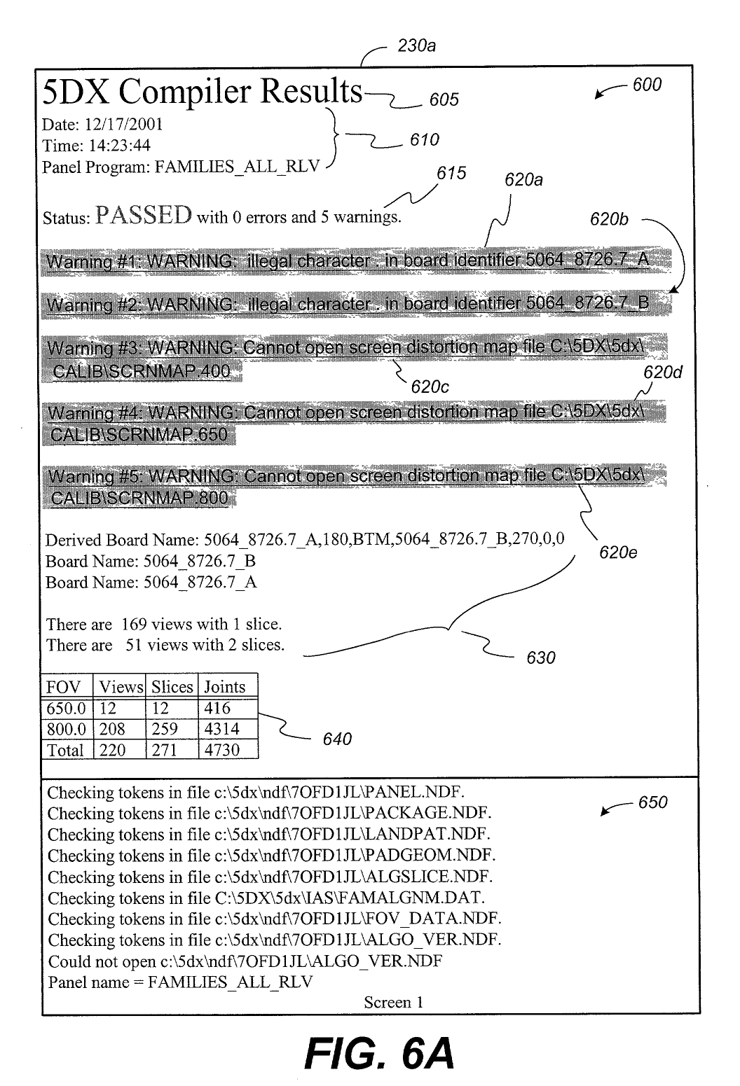

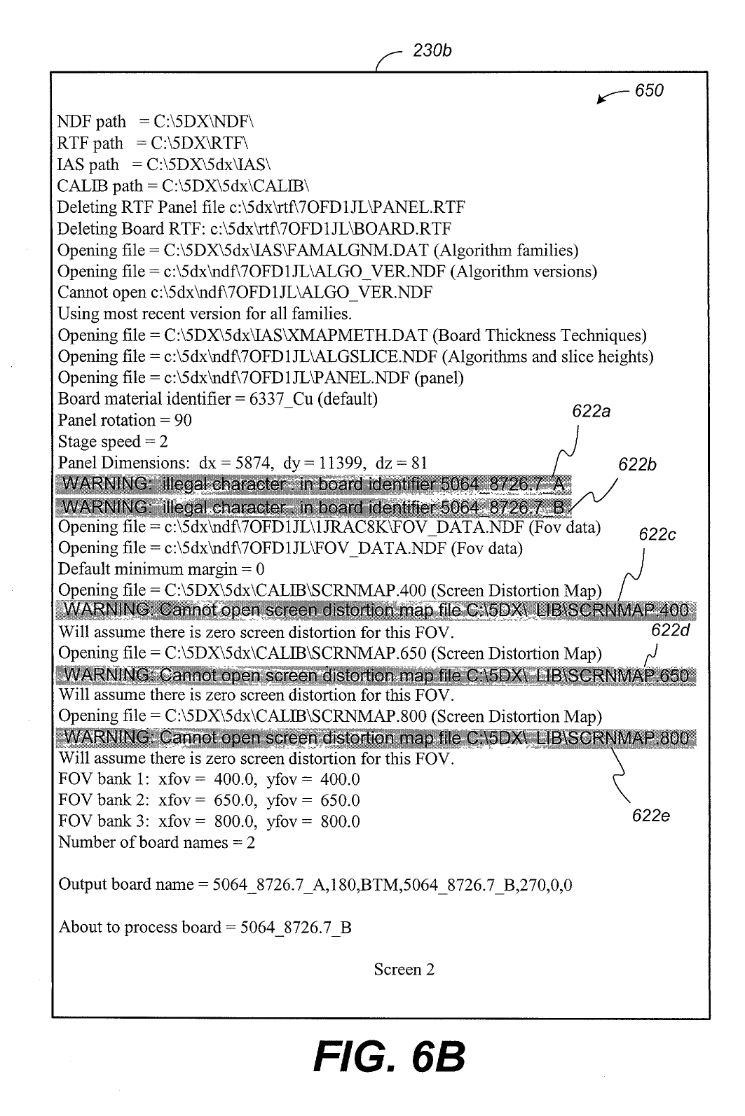

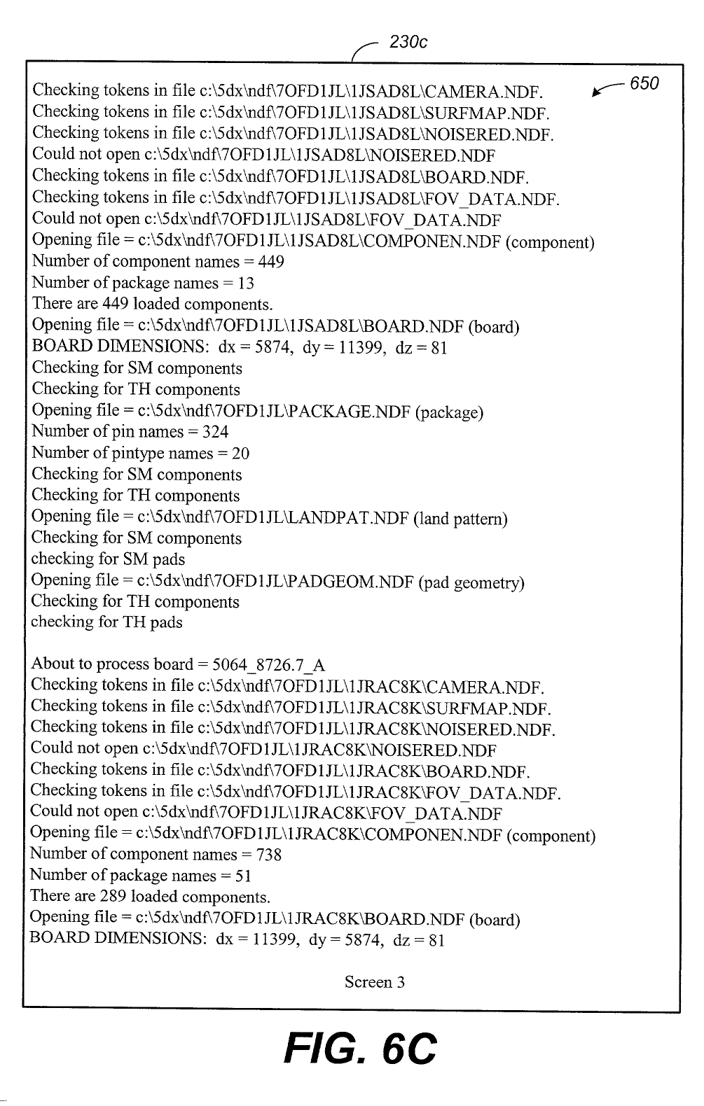

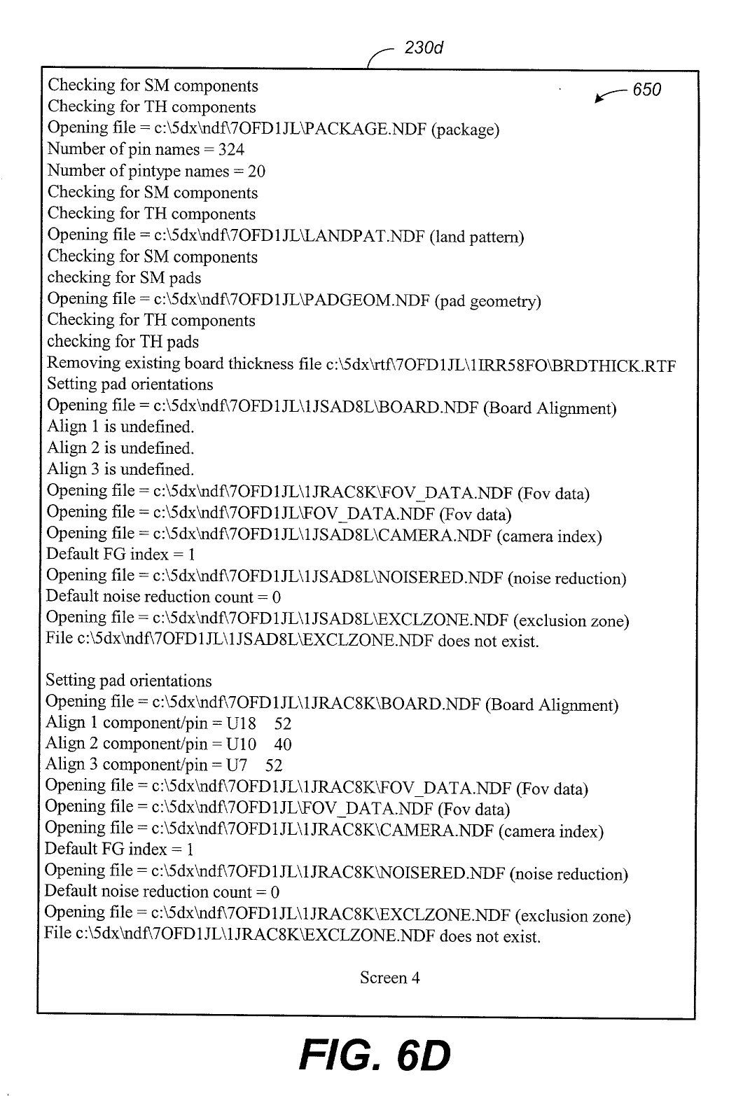

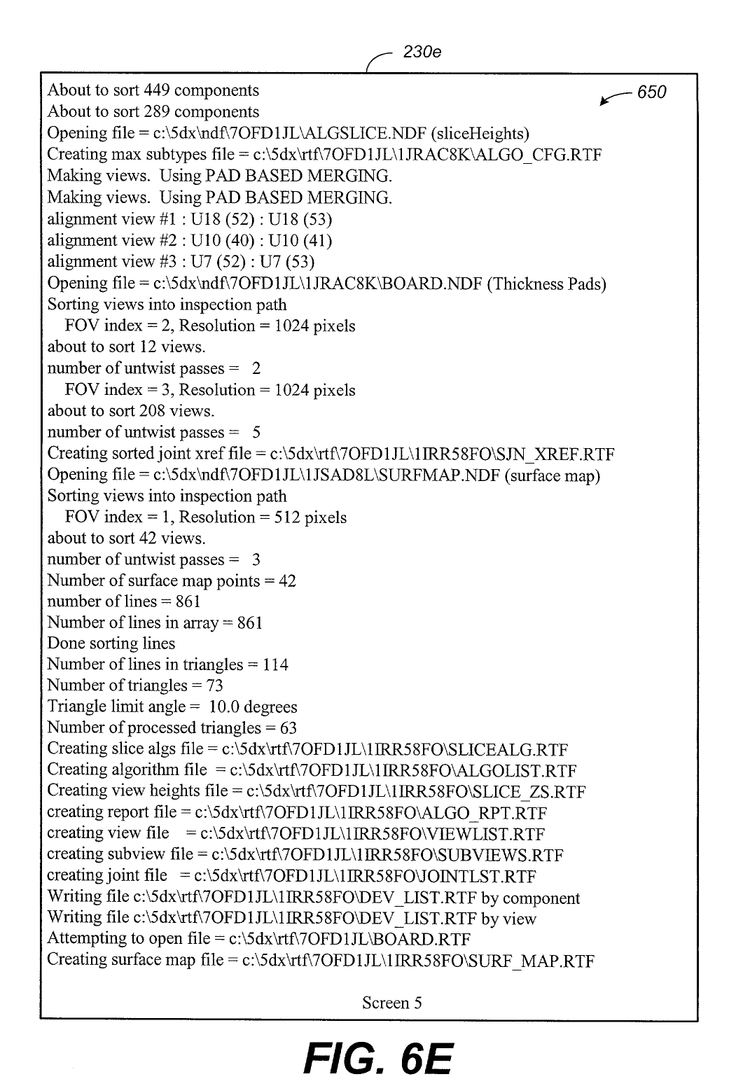

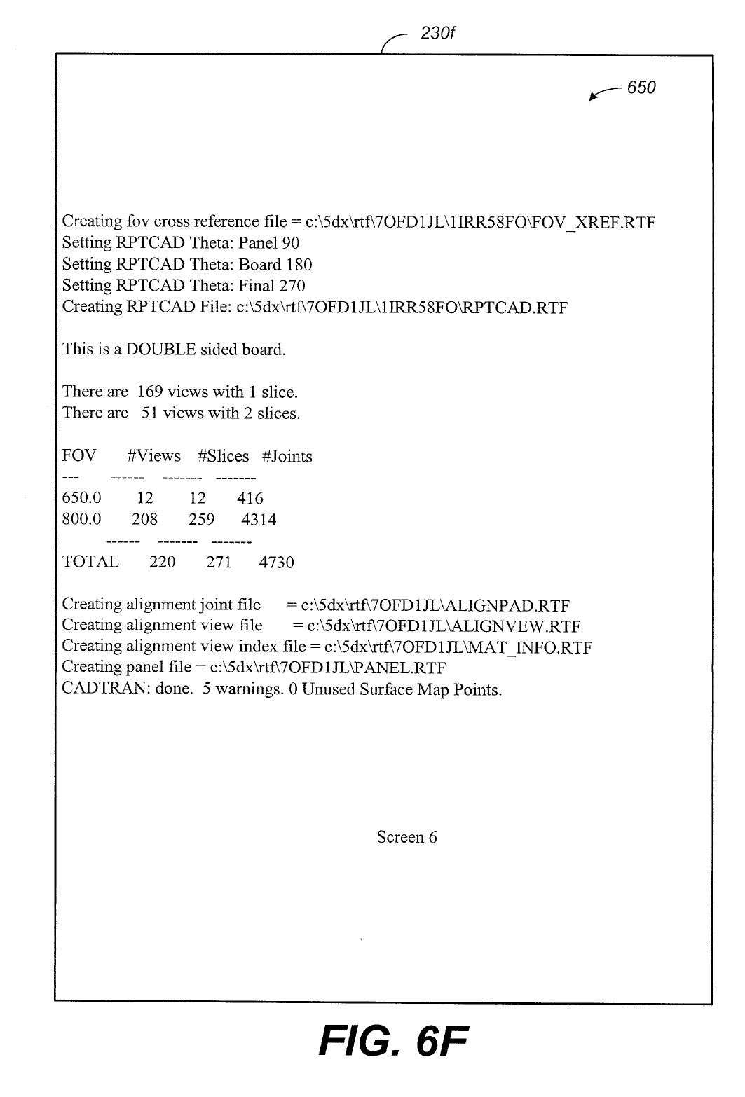

To facilitate description of the present invention, an exemplar text enhancer is presented and described with reference to the figures. The exemplar text enhancer and associated method for navigating summarized textual data are provided for purposes of illustration only. The exemplar text enhancer and associated method are illustrated using a sample compiler output generated by the 5DX X-ray Inspection System as illustrated in FIGS. 5A-5E. A text enhancer may be programmed to generate the enhanced compiler output illustrated in FIGS. 6A-6E. Various modifications are feasible without departing from the inventive concept of the text enhancer and the associated method for navigating summarized textual data.

A commercially available solder-joint inspection system, such as the 5DX X-ray Inspection System available from Agilent Technologies of Palo Alto, Calif., generates a compiler output that can contain multiple pages of text. The compiler output may include a list of the various data files and algorithms that will be used by the 5DX to formulate a thorough inspection of the various solder-joint interfaces on the printed circuit assembly (i.e., a device populated printed circuit board). The exemplar text enhancer may be added to the 5DX to provide a compiler output (e.g., a text file) that is more easily interpreted by a programmer or other operator of the 5DX. When the exemplar text enhancer is configured to provide a hard copy of the compiler output, the text enhancer may be configured to emphasize particular text strings and occurrences of the particular text strings found within the compiler output.

In system configurations that include a display device, the text enhancer may be configured to insert a link between an entry in a data summary and the underlying text information within the compiler output responsible for generating the entry in the data summary.

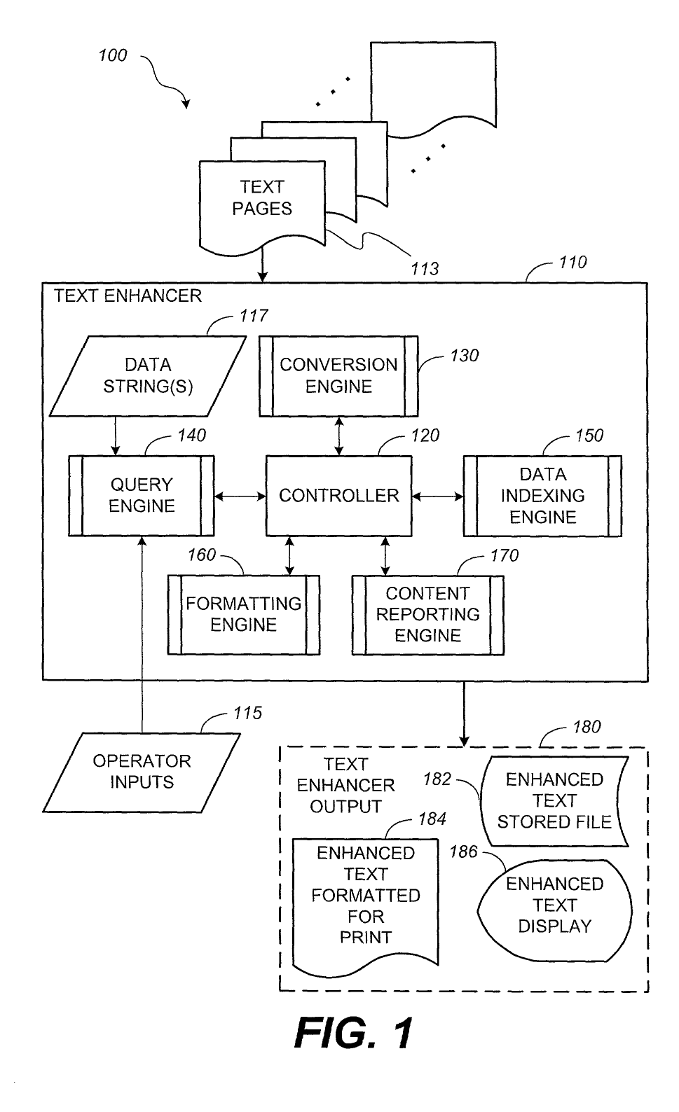

Reference is directed to the various exemplar embodiments as illustrated in the figures. In this regard, FIG. 1 presents a functional block diagram illustrating the operational environment 100 surrounding an exemplar text enhancer 110. As illustrated in FIG. 1, the text enhancer 100 may receive text pages 113 and in response to various inputs may generate a text enhancer output 180.

The text enhancer 110 may be configured to receive text pages 113 in the form of one or more data files. The text pages 113 as described above may contain a plurality of pages of detailed textual data including a list of data files and/or other information. In accordance with present operating systems the data files may be described by the concatenation of a data path and a filename. Those skilled in the art will appreciate the difficulty with reviewing detailed textual data in this format.

The text enhancer 110 may be configured to receive operator inputs 115 to ensure that an operator tasked with reviewing and/or correcting the various detailed textual data included within the text pages 113 does not overlook an important message or messages located within the text pages 113. The operator inputs 115 may include one or more strings of text data of interest to the operator. For example, in the case where the detailed textual data within the test pages 113 is in the form of a compiler output, the operator may be interested in any data line containing the text string “error.” By way of further example, the operator may be interested in data lines including the text string “warning.”

As is further illustrated in the functional block diagram of FIG. 1, the text enhancer 110 may receive one or more other data string(s) 117 that may be important to bring to the attention of an operator tasked with reviewing and/or correcting the information in the text pages 113. In this way, the text enhancer 110 can identify both predetermined data strings (e.g., data string(s) 117 previously stored in a memory device) and operator selectable data strings (e.g., operator inputs 115).

The text enhancer 110, having received the text pages 113, the operator inputs 115, and the data string(s) 117 may process the various inputs via one or more of the conversion engine 130, the query engine 140, the data-indexing engine 150, the formatting engine 160, and the content-reporting engine 170. As shown, each of the aforementioned text enhancer units (i.e., the conversion engine 130, the query engine 140, the data-indexing engine 150, the formatting engine 160, and the content-reporting engine 170) may be controlled by a controller 230. The controller 230 may be configured to coordinate operation of and transfers between the various text enhancer units as may be required.

In accordance with preferred embodiments, the conversion engine 130 is configured to translate the textual information within the text pages 113 into a hypertext markup language (HTML) format. The HTML version of the textual information may then be processed by the query engine 140 to locate matches between one or more text strings and the underlying text. Those skilled in the art will appreciate that in alternative embodiments the textual information may be processed by the query engine 140 before processing by the conversion engine 130. Regardless of the order, the query engine 140 may be configured to insert information into the textual information indicative of each occurrence of a match between a string or strings in the text with one or more strings entered via the operator inputs 115 and the data string(s) 117.

The content-reporting engine 170 may be configured to generate data summary entries. Each data summary entry may be inserted in the HTML version of the textual information by the formatting engine 170. Preferably, a data summary entry includes a label reflective of the underlying text string. For example, if the text string of interest is “error,” the data summary entry may read as follows: “ERROR #N: <STRING>,” where N is an integer equal to an error number and <STRING> is equivalent to the remainder of the data string from the underlying text. When it is the case that multiple occurrences of the same string of interest are encountered within the text information, the content-reporting engine 170 may generate a respective data summary entry indicative of the number of occurrences of the particular string. For example, if the string of interest is “Unable to open data file” the corresponding data summary entry generated by the content-reporting engine 170 may read as follows: “M unable to open data file errors encountered.” After generating data summary entries as described above, the formatting engine 160 may add titles, lines, and or other delimiters identifying the data summary from the underlying text which may be repeated in its entirety after the data summary. It should be appreciated that in alternative embodiments, the data summary may be presented at the end of the underlying text.

The data-indexing engine 150 may be configured to associate each of the data summary entries with the underlying text string responsible for generating the data summary entry. The data-indexing engine 150 may accomplish the association by providing a link between the entry in the summary and the underlying information in the representation of the textual data. In this way, the text enhancer 110 provides a data summary along with the capability to navigate the underlying data.

A link may be indicated by any of a number visual indicators shared by the entry in the summary and the underlying information within the text. A link indicator may be inserted by the data-indexing engine 150 in accordance with the desired text enhancer output 180. For example, when the summary and text are designated for presentation in a hard-copy format, such as print format 184, the link may be indicated by color with both the summary information and the underlying text sharing the same color print. When presented in the print format 184 with a single color font, the link may be indicated by a link identifier formed by any combination of desired alphanumeric characters (e.g., a number, a character, a label, etc.) When the summary and text are designated for storage in a data file 182, the link may be indicated by changing the font of both the entry in the summary and the associated data in the text and by various other methods.

When presented by way of a display device having a graphical user interface (GUI), such as, the enhanced text display 186, a link may also include a pointer or other mechanism that associates the entry in the summary and the underlying text in the body of the data, thereby allowing a user to quickly navigate through both the summary and the underlying data by jumping to the associated text in the body when the associated entry in the summary is selected and jumping back to the associated entry in the summary when the associated data in the body of the text is selected. Because the underlying text data has been translated into HTML, the link may be formed by creating an HTML link between the data summary entry and the transformed text data such that a user of the system can navigate between the various linked portions of the text enhancer output 180.

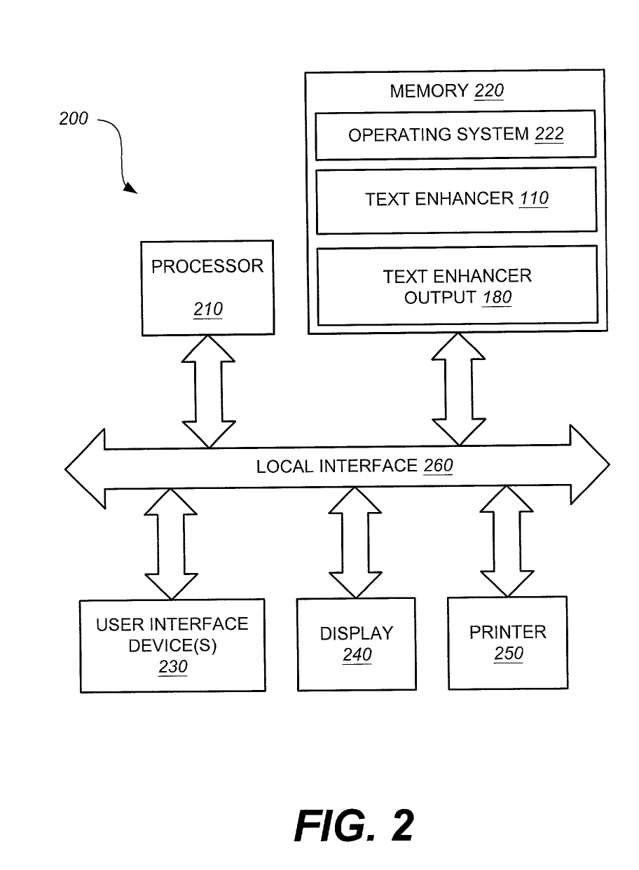

Reference is now directed to FIG. 2, which presents a diagram illustrating the various components of an exemplar-computing device 200 configured with the text enhancer 110 of FIG. 1. Generally, FIG. 1 is a schematic illustrating the various functional building blocks of a computer device 200 that can process logic configured to practice the method for navigating summarized data. Generally, the computer device 200 can comprise any one of a wide variety of wired and/or wireless computing devices, such as a desktop computer, a portable computer, a dedicated server computer, a multi-processor computing device, among others. Irrespective of its specific arrangement, the computing device 200 can, for instance, comprise a processor 210, memory 220, user interface devices 230, a display 240, and a printer 250, each of which may be connected with each other via a local interface 260.

The processor 210 can include any custom made or commercially available processor, a central processing unit (CPU) or an auxiliary processor among several processors associated with the computing device 200, a semiconductor based microprocessor (in the form of a microchip), a macro-processor, one or more application-specific integrated circuits (ASICs), a plurality of suitably configured digital logic gates, and other well known electrical configurations comprising discrete elements both individually and in various combinations to coordinate the overall operation of the computing device 200.

The memory 220 can include any one of a combination of volatile memory elements (e.g., random access memory (RAM, such as DRAM, SRAM, etc.)) and non-volatile memory elements (e.g., ROM, hard drive, tape, CDROM, etc.). The memory 220 typically comprises an O/S 222, one or more applications such as a text enhancer 110, and may include one or more instances of text enhancer output 180 (e.g., files). Persons having ordinary skill in the art will appreciate that the memory 220 can, and typically will, comprise other components, which have been omitted for purposes of brevity. These may include a host of programs configured to control various aspects of the computing device 200.

The user interface devices 230 comprise those components with which the user can interact with the computing device 200. For example, where the computing device 200 comprises a personal computer (PC), these components can comprise a keyboard and mouse. Where the computing device 200 is expected to be used in extreme environments (e.g., when it is located in close proximity to a solder flow machine as may be expected when the text enhancer 110 is stored within the 5DX), these components can comprise function keys or buttons, a touch-sensitive screen, a stylus, etc. The display 240 can comprise a computer monitor or plasma screen for a PC or alternatively a liquid crystal display (LCD) for a hand-held computing device 200 as may be desired. The printer 250 may be selected from a host of various types, including but not limited to, a single color printer (e.g., an inkjet, laser, and/or an impact printer). The printer 250 may also be a multiple color printer capable of recreating a host of various fonts, font sizes, colors, and other text characteristics such as bold text, italics, underlining, and the like.

Those skilled in the art will appreciate that the computing device 200 may be adapted to facilitate connection to another system and/or device and may therefore include one or more serial, parallel, small computer system interface (SCSI), universal serial bus (USB), IEEE 1394 (e.g., Firewire™), and/or other interface components that may be used to communicatively couple the computing device 200 with one or more remote data storage devices for recording compiler outputs as well as test measurement results. The computing device 200 may be coupled with a remote storage device (not shown) via a device that can communicate both inputs and outputs, for instance, a modulator/demodulator (e.g., a modem), wireless (e.g., a radio-frequency (RF)) transceiver, a telephonic interface, a bridge, a router, a network card, etc.

Various software and/or firmware will be used to receive, manage, coordinate, record, manipulate, and store text enhancer information error values, as well as to insert links, among other functions. The related software and/or firmware responsible for theses and other functions associated with the use of the underlying computing device 200 can be stored on any computer-readable medium for use by or in connection with any computer-related system or method. In the context of this document, a computer-readable medium denotes an electronic, magnetic, optical, or other physical device or means that can contain or store a computer program for use by or in connection with a computer-related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium include an electrical connection having one or more wires, a portable computer diskette, a random access memory (RAM), a read-only memory (ROM), an erasable programmable read-only memory (EPROM), an electrically erasable programmable read-only memory (EEPROM), or Flash memory, an optical fiber, and a portable compact disc read-only memory (CDROM). Note that the computer-readable medium can even be paper or another suitable medium upon which a program is printed, as the program can be electronically captured, via for instance, optical scanning of the paper or other medium, then compiled, interpreted or otherwise processed in a suitable manner as necessary, and then stored in a computer memory.

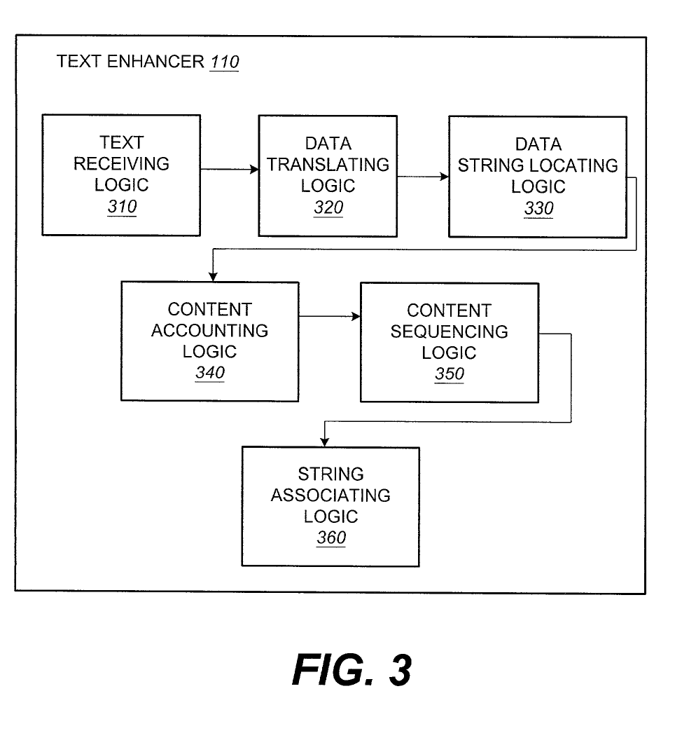

FIG. 3 presents a diagram illustrating the various functional logic that may be included within the text enhancer 110 of FIGS. 1 and 2. In this regard, the text enhancer 110 may include text-receiving logic 310, data-translating logic 320, data-string locating logic 330, content-accounting logic 340, content-sequencing logic 350, and string-associating logic 360.

The text-receiving logic 310 may be configured to buffer the entire contents of the text pages 113 (FIG. 1). The text-enhancer 110 may also be configured to read one line of text information at a time due to memory limitations. This alternative may become necessary for larger files. Once the text enhancer 110 has received and buffered the contents of the text pages 113, the data-translating logic 320 may be applied over the contents of the text pages 113 to create a modified version of the underlying text data. As described above, in preferred embodiments, the data-translating logic may be configured to generate an HTML version of the textual information associated with the text pages 113.

The data-string locating logic 330 may then be applied by the text enhancer 110 over the contents of the text pages 113 as stored in the modified HTML version. The data-string locating logic 330 is configured to indicate when a match for a particular string of text characters is encountered in the modified HTML version of the text pages 113. In accordance with preferred embodiments of the text enhancer 110, the data-string locating logic 330 inserts a separate and distinct indicator for each of a plurality of text strings of interest.

Next, the content-accounting logic 340 may be applied to the output of the data-string locating logic 330 in order to generate statistics regarding the one or more text strings of interest. For example, the number of occurrences of each text string of interest may be calculated. The statistics may then be forwarded to the content-sequencing logic 350. The content-sequencing logic 350 may be configured to generate and arrange data summary entries. Each data summary entry may be inserted in the HTML version of the textual information. When multiple occurrences of the same string of interest are encountered within the text information, the content-sequencing logic 350 may generate a respective data summary entry indicative of the number of occurrences of the particular string. The data summary entries may also include other delimiters such as lines and/or other characters reproducible by a display 240 (FIG. 2) and/or a printer 250 (FIG. 2) as may be desired.

The string-associating logic 360 may be configured to associate each of the data summary entries with the underlying text string responsible for generating the data summary entry. The string-associating logic 360 may accomplish the association by inserting a HTML link between the entry in the summary and the underlying information in the representation of the textual data. In this way, the text enhancer 110 provides a data summary along with the capability to navigate the underlying data.

In embodiments where the text enhancer output 180 (FIG. 1) is designated for transmission to the printer 250, a non-HTML link may be indicated by any of a number visual indicators shared by the entry in the summary and the underlying information within the text. A non-HTML link may be indicated by color with both the summary information and the underlying text sharing the same color print. In addition, an identifier consisting of alphanumeric characters may indicate a non-HTML link.

The text enhancer 110, when formed by a series of executable software commands as in the example of FIG. 3, can be written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada. In the currently contemplated best mode of practicing the invention, the text enhancer 110 is written in Perl.

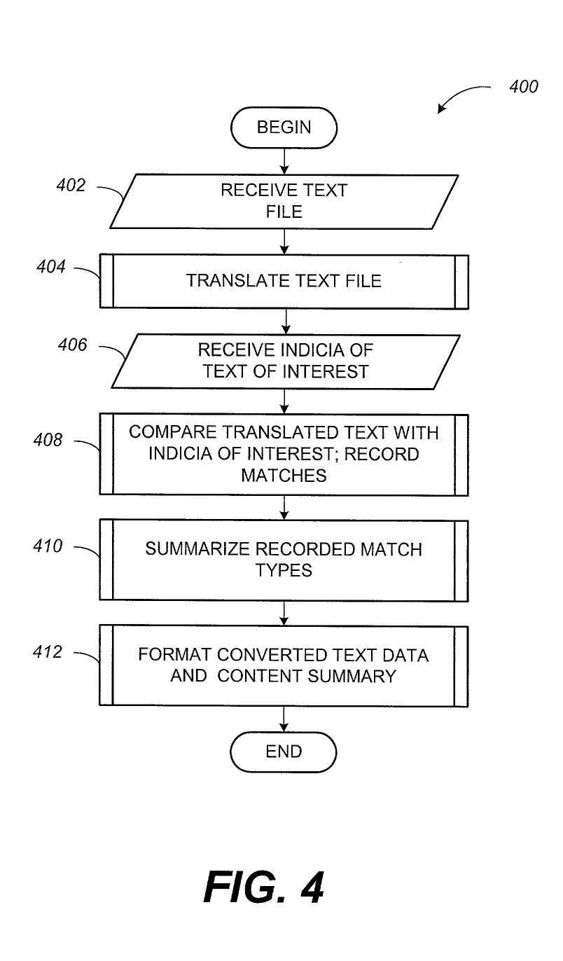

The text enhancer 110 having been illustrated and described above with regards to FIGS. 1 and 3, reference is now directed to FIG. 4, which presents a flow diagram that illustrates a method for navigating summarized textual data that may be practiced by the text enhancer of FIGS. 1 and 3. As illustrated in FIG. 4, a method for navigating summarized data 400 may begin with step 402 where a text file is received. A computing device 200 (FIG. 2) practicing the method for navigating summarized data 400 may be configured to translate the text file as indicated in step 404. Next, as indicated in step 406 the computing device 200 may be configured to receive indicia of text of interest. The text of interest may be previously stored in a memory device such as memory 220 (FIG. 2). Alternatively, the text of interest may be entered by an operator of the computing device 200 via a GUI and/or other well known data entry methods.

After receiving indicia of the text of interest in step 406, the computing device 200 may be configured to compare the translated text with the text of interest and record any matches discovered within the translated text as indicated in step 408. Next, the computing device 200 may be configured to summarize the recorded matches as illustrated in step 410. Note that recorded matches may be summarized by type. For example, all text messages containing the word “warning” may be presented in a portion of the data summary separate from other text strings that have been previously programmed for inclusion in the summary and/or text strings entered by an operator of the text enhancer 110. By way of further example, when the text enhancer 110 identifies matches of various types (e.g., errors, warnings, etc.) the text enhancer 110 may be programmed to insert a label indicating the total number of text lines and/or other text portions containing matches of each particular type. Thereafter, as indicated in step 412, the text enhancer 110 may be configured to arrange and or format the content summary and the converted text data as may be desired.

FIGS. 5A-5E present an exemplar representation of each page of a multiple page text file that may be provided to the text enhancer of FIGS. 1 and 2. As illustrated in FIG. 5A, a first text page 113a may include a number of lines of text. In the present example, the text includes a compiler output from the 5DX solder-joint inspection system. The compiler output includes a list of files that the solder-joint inspection system relies upon in order to construct an inspection test for a particular circuit assembly. Because of the similarity of file storage paths, filenames, and activities attempted by the test compiler, it can be particularly difficult to identify each separate occurrence of a particular text string on the text page 113a. For example, a programmer or other operator of the 5DX, may miss the two occurrences of the text, “not open” indicative of a failure of the file management system to locate and/or access the contents of the identified file.

Furthermore, a programmer or other operator of the 5DX, may miss the two occurrences of the text, “WARNING,” together with “illegal character ‘.’ in board identifier” and both occurrences of “WARNING,” together with “Cannot open screen distortion map file.” Moreover, a programmer or other operator tasked with reviewing and/or correcting various items included in the text pages 113 may overlook the fifth warning message on page 113b (FIG. 5B) and/or the two additional occurrences of the text, “not open.”

In response to some of the problems with overlooking important information contained within the underlying text of text pages 113a through 113e, FIGS. 6A-6E present an exemplar representation of each screen of a multiple screen display that may be generated by the text enhancer 110 of FIGS. 1 and 2 when presented the multiple page text file of FIGS. 5A-5E. In this regard, a first content summary screen 230a may include a text content summary 600 and a first portion of the underlying text 650 as provided on the first text page 113a. As illustrated in FIG. 6A, the text content summary 600 may include a title 605, an information field 610, a status field 615, a text matching field including a separate listing of each occurrence of a text string of interest, miscellaneous information 630, and a table 640. The title 605, as illustrated, may be presented in a text style, font, and/or font size that sets it apart from other text within the content summary screen 230a. Information field 610 may be used to reflect the date, time, and the test program processed by the 5DX. The status field 615 may include an indication of pass or fail, as well as, a statistical result reflective of the various text strings of interest. For the example illustrated in summary screen 230a, the text enhancer 110 was programmed to search, record, and display matches with text lines containing “errors” and “warnings.”

As further illustrated in the content summary 600 of FIG. 6A, a plurality of links 620a-620e may be inserted. As described above, when the summary screen 230a is associated with a GUI, a viewer/operator of the GUI may navigate through the contents of the underlying data 650 by selecting a link 620. When the operator of the GUI has made such a selection, the GUI may respond by adjusting the display screen such that the associated content 622 responsible for the link 620 is displayed and the cursor indicating the location of a pointing device used for operating the GUI may be co-located over the respective content. For example, when a viewer/operator of the GUI selects link 620c, the GUI will adjust the display and the cursor to present the associated content 622c, herein labeled, “WARNING: Cannot open screen distortion map file C:\5DX\LIB\SCRNMAP.400.”

As also described above, when it is the case that a hard-copy output of the summary is desired, the various links 620a-620e may be indicated on the output by presenting the associated content 622a-622e in the same text color, with the same font, font size, font style, among other indicators. In addition, links 620 may be concatenated with one or more alphanumeric labels to set each respective occurrence of a text match apart from other text matches of the same type.

As also illustrated in FIG. 6A, miscellaneous information 630 may include an assembly name for the assembly under test, as well as a separate identifier for each side of a multiple sided printed circuit board. In addition, the content summary 600 may include a plurality of table delimiters (e.g., lines) that separate and draw attention to table 640.

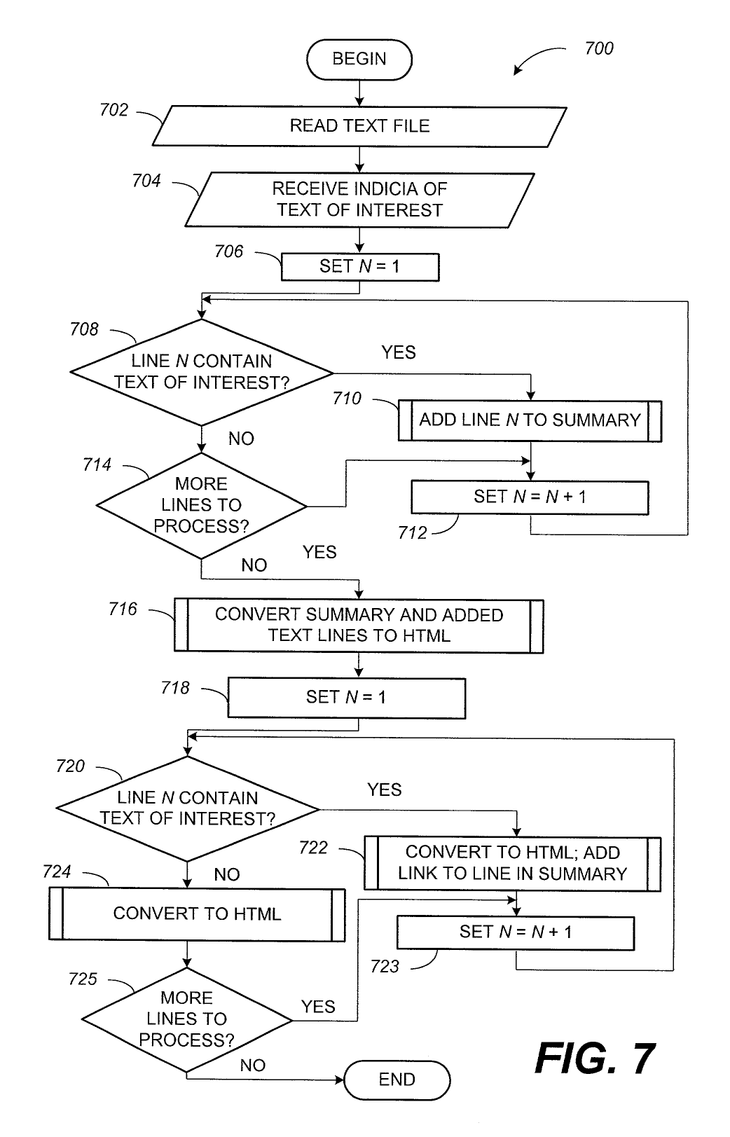

Reference is now directed to FIG. 7, which presents a flow diagram that illustrates a method for summarizing and navigating between the summary information and underlying textual data in a report that may be practiced by the text enhancer 110 of FIGS. 1 and 3. As illustrated in FIG. 7, the method 700 may begin with step 702 where a text file is accessed. A computing device 200 (FIG. 2) practicing the method 700 may be configured to receive text strings of interest as indicated in step 704. As described above, the text strings of interest may be communicated to the computing device 200 via an interface or alternatively the text strings of interest can be stored within a data storage device in communication with the computing device 200. Next, as illustrated in the query of step 708, the computing device 200 practicing the method 700 may determine if the first line of text contains a string of text that matches a text string of interest received in step 704. When it is the case that the first line of text does contain a match with a text string of interest, the computing device 200 may add the line of text to an appropriate summary label to generate a summary line as indicated in step 710. After incrementing the counter in step 712, the computing device 200 may be programmed to return to step 708 to analyze subsequent data lines for matches.

Otherwise, when it is the case that the first (and any subsequent data line) does not contain a match with the text strings of interest, the computing device 200 may be programmed to perform the query of step 714 where a determination is made if further data lines exist. When the query of step 714 indicates that more data lines need to be processed, the computing device 200 may be programmed to increment the counter as illustrated in step 712 and check the next data line as described above. When the query of step 714 indicates that the lines of the data file have been exhausted, the computing device 200 may be programmed to convert each of the summary lines into an HTML version of the report summary as indicated in step 716. Those skilled in the art will appreciate that appropriate HTML code that identifies an HTML file may be inserted as part of step 716. Those skilled in the art will also appreciate that the appropriate HTML code may be inserted in the summary lines to allow HTML links from the summary lines to the original text as part of step 716.

Next, as illustrated in step 718, the computing device 200 practicing the method 700 may be programmed to reset the counter and check the first line of the data file for text that matches the text strings of interest as indicated in the query of step 720. When it is the case that the present line contains a text string that matches a text string of interest, the computing device 200 may be programmed to convert the present line into an HTML version of the line of text, add the line to the report, and insert HTML code that associates the present line of text with an associated line of text in the previously generated summary as illustrated in step 722. Thereafter, as shown in step 723, the computing device 200 may increment the counter and return to step 720 to check the next line.

Otherwise, when it is the case that the query of step 720 indicates that the present line does not contain a match with the text string of interest, the line may be converted into an HTML version of the line and added to the report. Next, the computing device may check if additional lines of text need to be searched for a match with the text strings as indicated in the query of step 725. When it is the case that additional lines need to be processed, the computing device 200 may be programmed to increment the counter as illustrated in step 723 and return to step 720. Otherwise, when it is the case that each of the lines of the file have been checked and added to the report, the computing device 200 may be programmed to terminate the method 700. Those skilled in the art will appreciate that the generated report may be terminated by adding the appropriate HTML code that identifies the end of an HTML file.

Any process descriptions or blocks in the flow charts of FIGS. 4 and 7 should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

Furthermore, while particular embodiments of the text enhancer 110 have been disclosed in detail in the foregoing description and drawings for purposes of example, it will be understood by those skilled in the art that variations and modifications thereof can be made without departing from the scope of the invention as set forth in the following claims.

Thus, having described the text enhancer and method for summarizing textual data, I claim the following:

1. A method for navigating summarized textual data, comprising:
transforming data from a text format to a hypertext markup language format;
receiving a portion of text;
comparing the data with the portion of text to identify a match;
generating an entry responsive to the match;
inserting the entry in a data summary; and
associating the entry with the contents of the transformed data responsible for the match.

2. The method of claim 1, wherein receiving comprises reading a string of text from a data storage device.

3. The method of claim 1, wherein receiving comprises reading a string of text from an input device.

4. The method of claim 1, wherein generating comprises concatenating a string of text to the data responsible for the match to a label.

5. The method of claim 4, wherein the label is reflective of a level of importance.

6. The method of claim 5, wherein the level of importance is indicated via a color.

7. The method of claim 5, wherein the level of importance is indicated via a label.

8. The method of claim 1, wherein the string of text includes language indicative of a condition requiring correction.

9. The method of claim 1, wherein associating comprises adding a pointer indicative of the location of the string of text within the data.

10. The method of claim 9, wherein the pointer comprises a hypertext markup language link.

11. The method of claim 1, wherein associating comprises changing a characteristic of both the data and the entry in the data summary.

12. The method of claim 11, wherein the characteristic is selected from the group consisting of color, font, font size, bold text, italicized text, and underlined text.

13. The method of claim 1, wherein associating comprises adding an alphanumeric to the data and the entry in the data summary.

14. A text enhancer, comprising:
means for receiving a text file having a plurality of lines of information;
means for comparing the plurality of lines of information with a string to generate a match;
means for compiling a statistic on the match; and
means for converting the text file to a hypertext markup language (HTML) translation of the text file.

15. The text enhancer of claim 14, further comprising:
means for reporting the statistic.

16. The text enhancer of claim 14, further comprising:
means for applying a hypertext markup language link between the statistic and an instance of the string in the match.

17. The text enhancer of claim 14, wherein the means for comparing receives a previously stored string.

18. The text enhancer of claim 14, wherein the means for comparing receives a string via an input device.

19. A program stored on a computer-readable medium, comprising:
logic configured to receive text data;
logic configured to locate a text string within the text data;
logic configured to log located text strings, wherein each occurrence of a particular text string is associated with an indicator;
logic configured to translate the text data to a hypertext markup language format;
logic configured to register a respective label in a text data summary; and
logic configured to associate a particular label with occurrences of the particular text string located within the text data.

20. The program of claim 19, wherein the logic configured to log located text strings records a number of occurrences of the particular text string.

21. The program of claim 19, wherein the logic configured to register a respective label concatenates the number of occurrences of the particular text string to the label to generate a summary entry.

22. The program of claim 21, wherein the logic configured to associate a particular label adds a link.

23. The program of claim 22, wherein the link comprises changing a characteristic of both the text string in the text data and the summary entry.

24. The program of claim 22, wherein the link comprises adding an alphanumeric character to both the text string and the summary entry.

25. The program of claim 22, wherein the link is a hypertext markup language link.

26. A computer system, comprising:
a processor;
an execution memory communicatively coupled to the processor; and
a text enhancer application stored within the execution memory, wherein the text enhancer application comprises:
a conversion engine configured to transform text data into hypertext markup language;
a query engine configured to locate a match between a text string and the text data;
a content reporting engine configured to generate an entry responsive to a number of located matches;
a data indexing engine configured to associate the text string and the text data such that a user of the system can navigate between the entry and the text data.

27. The system of claim 26, wherein the query engine is configured to locate a match between a previously stored text string and the text data.

28. The system of claim 26, wherein the query engine is configured to locate a match between a user entered text string and the text data.

29. The system of claim 26, wherein the text enhancer application further comprises:
a formatting engine configured to insert an entry in a data summary responsive to a number of occurrences of the match.

30. The system of claim 29, wherein the formatting engine is configured to change a characteristic of both the text data and the entry.

31. The system of claim 29, wherein the formatting engine is configured to concatenate an alphanumeric label to the text data and the entry.

32. The system of claim 29, wherein the formatting engine is configured to insert a hypertext markup language link between the text data and the entry.

33. A method for navigating between summary information and textual data in a report, comprising:
identifying a text string;
associating a summary label with the text string;
accessing a text file containing a plurality of lines of textual information;
determining if each of the plurality of lines contains the text string, wherein when a line of textual information contains the text string, the line of textual information is added to the summary label to generate a summary line in the report;
translating the summary line to a hypertext markup language (HTML) format;
accessing the text file containing a plurality of lines of textual information;
determining if each of the plurality of lines contains the text string, wherein when a line of textual information does not contain the text string, the line of textual information is translated to an HTML format and concatenated to the summary line in the report and when a line of textual information does contain the text string, the line is translated to an HTML format with HTML code that associates the line of textual information to the summary line, the line of textual information containing the text string appended to the report.

34. The method of claim 33, further comprising:
inserting an hypertext markup language file header.

35. The method of claim 34, wherein the HTML file header is inserted before the summary lines in the report.

36. The method of claim 33, further comprising:
inserting an hypertext markup language file footer.

37. The method of claim 36, wherein the HTML file footer is inserted after the plurality of lines have been appended to the report.

38. The method of claim 33, wherein HTML code that associates the line of textual information to the summary line comprises changing a characteristic of both the line of textual information and the summary line.

39. The method of claim 38, wherein the characteristic is selected from the group consisting of color, font, font size, bold text, italicized text, and underlined text.

40. The method of claim 33, wherein HTML code that associates the line of textual information to the summary line comprises adding an alphanumeric character to the line of textual information and the summary line.

41. The method of claim 33, wherein HTML code that associates the line of textual information to the summary line comprises a link.
